(19) United States
(12) Patent Application Publication
(10) Pub. No.: US 2011/0113785 A1
(43) Pub. Date: May 19, 2011

(54) THERMAL MACHINE

(75) Inventors: Remigi TSCHUOR, Windisch (CH); Russell Bond JONES, Jupiter, FL (US); Nilze Isabel SEDA-MAURELL, West Palm Beach, FL (US); Marion Oneil DUGGANS, West Palm Beach, FL (US)

(73) Assignee: ALSTOM TECHNOLOGY LTD, Baden (CH)

(21) Appl. No.: 12/852,788

(22) Filed: Aug. 9, 2010

Related U.S. Application Data
(63) Continuation of application No. PCT/EP2009/051644, filed on Feb. 12, 2009.

(30) Foreign Application Priority Data
Feb. 20, 2008 (CH) 00245/08

(51) Int. Cl. F02C 1/00; B23P 17/00

(52) U.S. Cl. 60/752; 29/888

(57) ABSTRACT

A thermal machine is provided, in particular a gas turbine, which includes an annular combustion chamber which is bounded on the outside by an outer shell and an inner shell. The outer shell and the inner shell are each split on a separating plane into an upper half and a lower half, which are mechanically interlocked by welding one to the other on the separating plane. Increased mechanical robustness and a longer life of the combustion chamber are achieved in that an additional mechanical interlock is provided on the separating planes in order to absorb tensile and shear forces acting on the separating planes.

### CROSS REFERENCE TO RELATED APPLICATION

This application is a continuation of International Application No. PCT/EP2009/051644 filed Feb. 12, 2009, which claims priority to Swiss Patent Application No. 00245/08, filed Feb. 20, 2008, the entire contents of all of which are incorporated by reference as if fully set forth.

### FIELD OF INVENTION

The present invention relates to the field of thermal machines, and in particular to a thermal machine, as well as a method for assembling such a thermal machine.

### BACKGROUND

Modern industrial gas turbines (IGT) are generally designed with annular combustion chambers. Most relatively small IGTs are in the form of so-called “can-annular combustors”. In the case of an IGT with an annular combustion chamber, the combustion area is bounded by the side walls and the inlet and outlet plane of the hot gas. One such gas turbine is illustrated in FIGS. 1 and 2. The gas turbine 10, a detail of which is illustrated in FIGS. 1 and 2, has a turbine housing 11 in which a rotor 12, which rotates about an axis 27, is accommodated. On the right-hand side, a compressor 17 is formed on the rotor 12 in order to compress combustion air and cooling air, and a turbine 13 is arranged on the left-hand side. The compressor 17 compresses air which flows into a plenum chamber 14. An annular combustion chamber 15 is arranged concentrically with respect to the axis 27 in the plenum chamber, is closed on the inlet side by a front plate 19 which is cooled by front plate cooling air 20, and is connected on the outlet side via a hot-gas channel 25 to the inlet of the turbine 13.

Burners 16 are arranged in a ring in the front plate 19, are, for example, in the form of premixing burners, such as those preferably disclosed in EP-A1-321 809 or EP-A1-704 657 and inject a fuel-air mixture into the combustion chamber 15. The cited documents and the further developments derived from them form an integrating component of this application. The hot-air flow 26 which is created during combustion of the mixture is passed through the hot-gas channel 25 into the turbine 13, where it is expanded, creating work. The combustion chamber 15 together with the hot-gas channel 25 is surrounded on the outside at a distance by an outer and an inner cooling jacket 21 and 31, respectively, which are attached to the combustion chamber 15, 25 by means of attachment elements 24 and in each case form an outer and an inner cooling channel 22 and 32, respectively, between themselves and the combustion chamber 15, 25. Cooling air flows in the cooling channels 22, 32 in the opposite direction to the hot-gas flow 26, along the walls of the combustion chambers 15, 25 along a combustion chamber shroud 18, and flows from there into the burners 16, and front plate cooling air 20 flows directly into the combustion chamber 15.

The side walls of the combustion chambers 15, 25 are in this case either in the form of shell elements or complete shells (outer shell 23, inner shell 33). When using complete shells, it is necessary for assembly purposes to provide a separating plane (29 in FIG. 4 et seq) which allows an upper half of the shell 23, 33 (the upper part) to be removed in order, for example, to fit or to remove the gas turbine rotor 12. The separating plane 29 correspondingly has two separating plane weld beads which, based on the example of the gas turbine designed by the applicant, are located at the same height as the machine axis 27.

Access is possible both from the hot-gas side and from the cooling-air side in order to weld the separating planes 29 on the outer shell 23. Access is ensured only from the hot-gas side for welding the separating planes on the inner shell 33 (access via a manhole in the turbine housing 11). The separation of a shell into an upper half and a lower half (upper part and lower part) and the welding after fitting of the rotor 12 are known from the prior art, and are normal practice.

Because the material characteristics of the weld bead are not as good as those of the basic material, and because of the lack of a thermal barrier coating (TBC) on and in the immediate vicinity of the weld beads, the side walls are less strong and have a shorter life in the area of the separating planes 29. The very severely thermally loaded outer and inner shells 23 and 33, respectively, result in high compression and tensile stresses being applied to the four separating planes (29 and so on). The required operating life of outer and inner shells 23 and 33, respectively, is typically two so-called service intervals (service cycles). A service interval describes the time between the (re)commission of the combustion chamber and the reconditioning of the components. Both shells, the outer and inner shells 23, 33, often start to tear in at the start and end of the separating plane weld beads during operation.

### SUMMARY

The present disclosure is directed to a thermal machine including an annular combustion chamber, which is bounded on the outside by an outer shell and an inner shell. The outer shell and the inner shell are each split on a separating plane into an upper half and a lower half, which are mechanically interlocked by welding one to the other on the separating plane. An additional mechanical interlock is provided on the separating planes in order to absorb tensile and shear forces acting on the separating planes.

The present disclosure is also directed to a method for assembling the above thermal machine. The method includes inserting a connecting element into the upper half of the respective shell, which is separated into an upper half and a lower half and placing the two halves one on top of the other. The method also includes driving the connecting element into the lower half of the respective shell and connecting the connecting element to the two halves in a final position.

### BRIEF DESCRIPTION OF THE DRAWINGS

The invention will be explained in more detail in the following text with reference to exemplary embodiments and in conjunction with the drawing. All of the elements which are not required for immediate understanding of the invention have been omitted. Identical elements are provided with the same reference symbols in the various figures. The flow direction of the media is indicated by arrows. In the figures:

FIG. 1 shows a longitudinal section through a cooled annular combustion chamber of a gas turbine according to the prior art;

FIG. 2 shows, in detail, the annular combustion chamber from FIG. 1 with the cooling jackets attached on the outside;

FIG. 3 shows a longitudinal section through the turbine-side end of the outer shell of the combustion chamber from FIG. 1 with the attached flange;

FIG. 4 shows, in the form of a detail, the halves of the outer shell, which abut against one another on the separating plane, with a screwed bridge arranged on the flange, according to one preferred exemplary embodiment of the invention;

FIG. 5 shows the detail from FIG. 4, viewed from a different direction;

FIG. 6 shows a first sub-step during the fitting of the bridge as shown in FIG. 4;

FIG. 7 shows, in various sub-figures (a), (b) and (c), various views of a bridge as shown in FIG. 4;

FIG. 8 shows, in the form of a detail, the halves of the outer shell, which abut against one another on the separating plane, with a screwed bridge arranged on the flange, according to another preferred exemplary embodiment of the invention;

FIG. 9 shows the detail from FIG. 8, viewed from a different direction;

FIG. 10 shows, in various sub-figures (a), (b) and (c), various views of a bridge as shown in FIG. 8, and

FIG. 11 shows, in two sub-figures (a) and (b), different views of a bridge provided with additional cooling means, in a similar manner to FIG. 10.

### DETAILED DESCRIPTION OF THE PREFERRED EMBODIMENTS

### Introduction to the Embodiments

The object of the invention is to provide a thermal machine, in particular a gas turbine, which avoids the abovementioned disadvantages of known machines and in particular prevents the combustion chamber shells from tearing in on the weld beads which connect the shell halves, and to specify a method for its assembly.

The object is achieved by the totality of the features of claims 1 and 16. It is essential for the invention that an additional mechanical interlock is provided on the separating planes in order to absorb tensile and shear forces acting on the separating planes.

In one preferred refinement of the invention, a connecting element which extends over the separating plane and is in the form of a bridge is in each case provided as the additional mechanical interlock, the outer shell and the inner shell have a flange at the inlet and/or outlet of the combustion chamber, the connecting elements are arranged on the outside of the flange, the flange has a circumferential groove on the outside, and the connecting elements are inserted into the groove.

The strength deficit which exists in the prior art can be compensated for by the retrospective incorporation of (cooled) screwed and/or welded integral bridges in the grooves of the (two) flanges at the location of the separating plane weld beads. The structure bridges in this case absorb the tensile and shear forces which occur at the start and end.

The connecting elements in this case may be detachably connected to the two halves of the outer shell and inner shell. In particular, the connecting elements are then detachably connected to the two halves of the outer shell and inner shell by screws or bolts.

However, the connecting elements may also be integrally connected, in particular welded, to the two halves of the outer shell and inner shell.

Another refinement of the invention is distinguished in that the groove and the connecting elements are designed such that the connecting elements are held in the groove by an interlock.

According to a further refinement, the connecting elements have first means in order to improve the mechanical integrity, wherein notches in the form of fillets are preferably provided at the ends as means in order to improve the mechanical integrity.

In another refinement, the connecting elements have second means in order to improve the assembly capability, with a stud preferably being provided on the upper face as means in order to improve the assembly capability.

A further refinement is distinguished in that the connecting elements have third means in order to improve the cooling of the connecting elements.

According to another refinement of the invention, the connecting elements have fourth means in order to form cooling channels between the connecting element and the flange, with a corrugated base surface preferably being provided on the lower face as means in order to form cooling channels.

In one refinement of the method according to the invention, in the first step, the connecting element is inserted loosely into the upper half, and is welded to the two halves in the final position.

In another refinement, in the first step, the connecting element is inserted into the upper half at its final position, and is secured by screws or bolts, and, in the third step, the upper half is positioned while the connecting element is driven in on the lower half at the same time.

### DETAILED DESCRIPTION

One major feature of the inventive idea is an additional mechanical interlock of the separating plane weld beads between the half-shells of the outer shell and/or inner shell of an annular combustion chamber (note: all the following explanatory notes and descriptions relate to the outer shell, but also apply in a corresponding manner to an inner shell). In this case, a bridge is used as an additional connecting element on both sides of the separating plane, preferably in a flange which is in each case already provided. This bridge may, but need not be, designed such that it still allows or makes possible cooling of the flange part.

The design implementation is in general subject to the following principles:
the bridges are designed to be virtually interlocking. As a result, they fit precisely into the respective flange geometry and are clamped in an interlocking manner during operation by the thermal deformation of the shells and of the flange.
the bridges should be located as close as possible to the “cold” shell outer wall in order that no further, unnecessarily high, lever-action forces occur.
the bridges can be welded, clamped in an interlocking manner, or screwed.
cooling air can be used in order to cool the lower face of the bridges in the immediate vicinity of the thermally loaded shell structure, in order to use the bridge to transmit stresses to a greater extent away from the separating plane weld bead.

In one practical embodiment of the inventive idea, the bridge is inserted into a flange groove on one side, in the upper part of the outer shell. The two shells are placed one above the other in the gas turbine (GT) and the bridge is pushed or knocked into its position (a stud or a tab on the external diameter of the bridge can in this case be used as a point of contact for a mandrel or hammer). As soon as the bridge is located in position above the separating plane, its upper face is welded to the flange. The geometrical configuration of the flange and of the bridge itself in this case preferably allows the cooling air to flow through the flange under the bridge—thus ensuring the preconditions for convection cooling.

Instead of the integral welded joint between the bridge and the flange, it is, however, also possible to use a detachable connection: the bridge is then inserted into the flange groove on one side, in the upper part (in the upper half) of the outer shell, and is positioned at its attachment point by one or more bolt. The two half-shells are placed one on top of the other in the gas turbine, and the bridge is driven into the lower half-shell. As soon as the two half-shells are located exactly one on top of the other, the bridge can also be secured in the lower half-shell (by bolts and/or screws). In order to improve the accessibility during welding of the separating plane, the bridge may also be removed and reinserted again at any time.

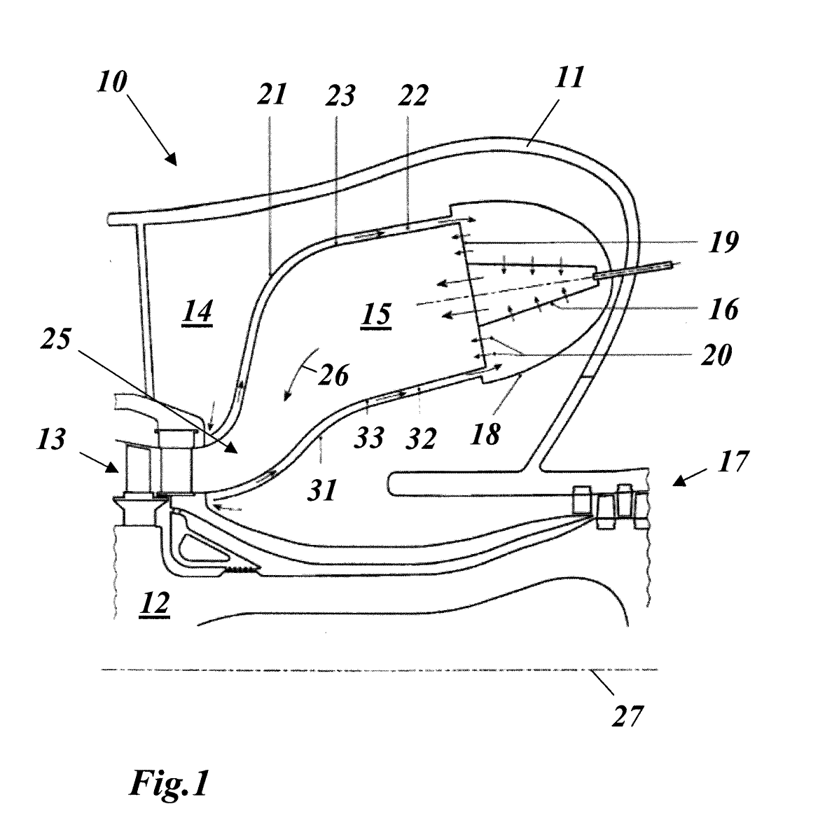

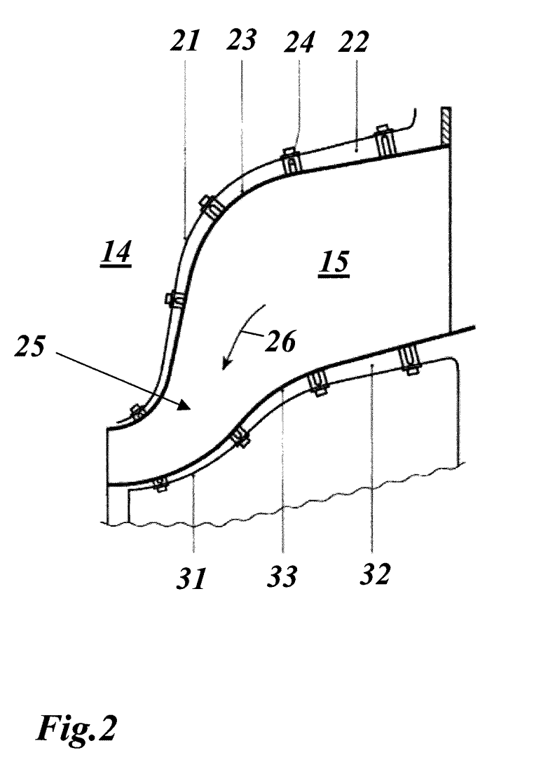

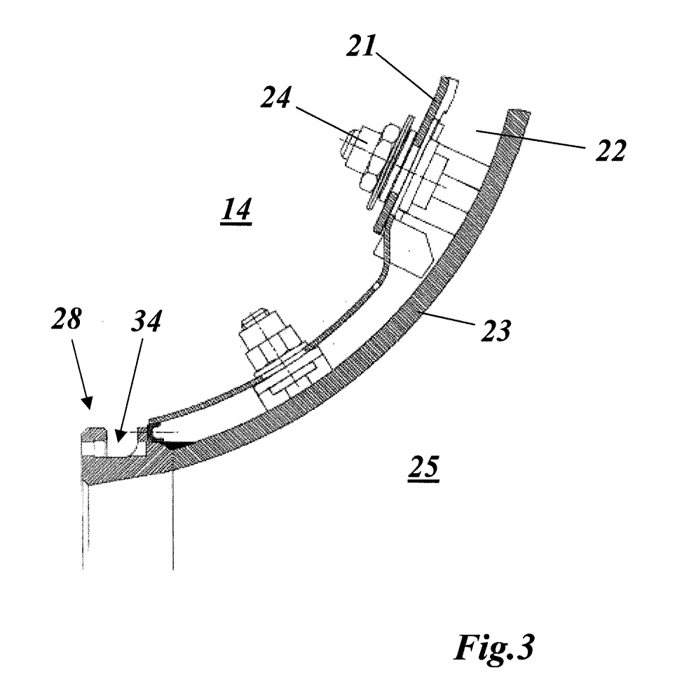

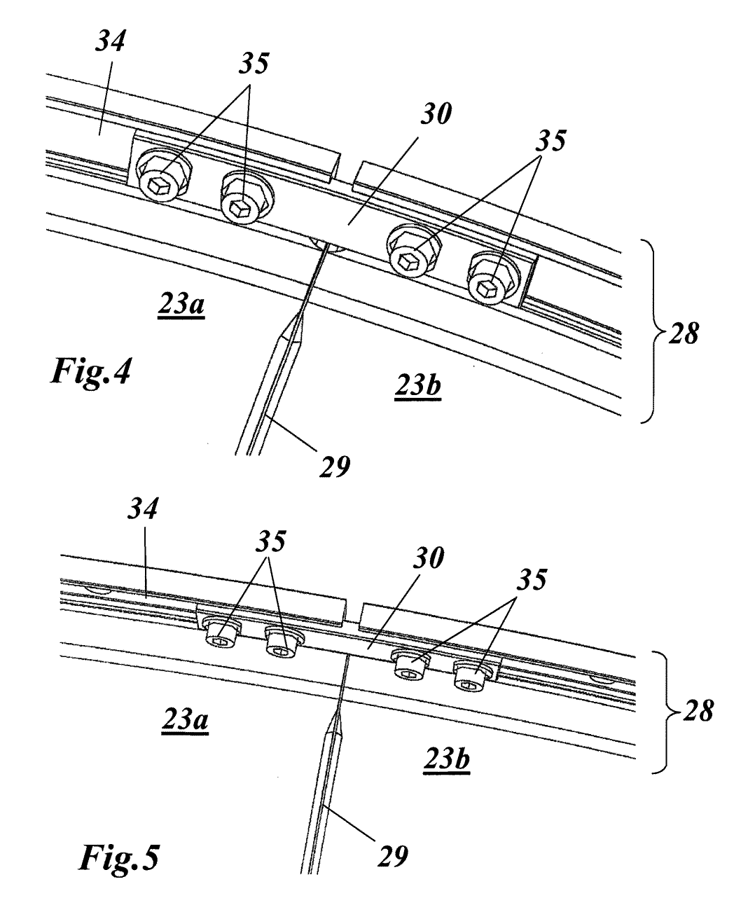

The two abovementioned alternatives (welded or screwed bridge) will be explained in the following text using the exemplary embodiments in FIGS. 4 to 11. The shells 23, 33 of the annular combustion chambers 15, 25 are preferably provided at the burner-side end and at the turbine-side end with flanges which are used for the connection between the combustion chamber and adjacent components. As an example, FIG. 3 shows, in the form of a longitudinal section, the turbine-side end of the outer shell 23 of the combustion chambers 15, 25 from FIG. 1 with the attached flange 28. On the outside, the flange 28 has a groove 34 which holds the bridges which are provided in order to reduce the mechanical load on the separating plane weld beads.

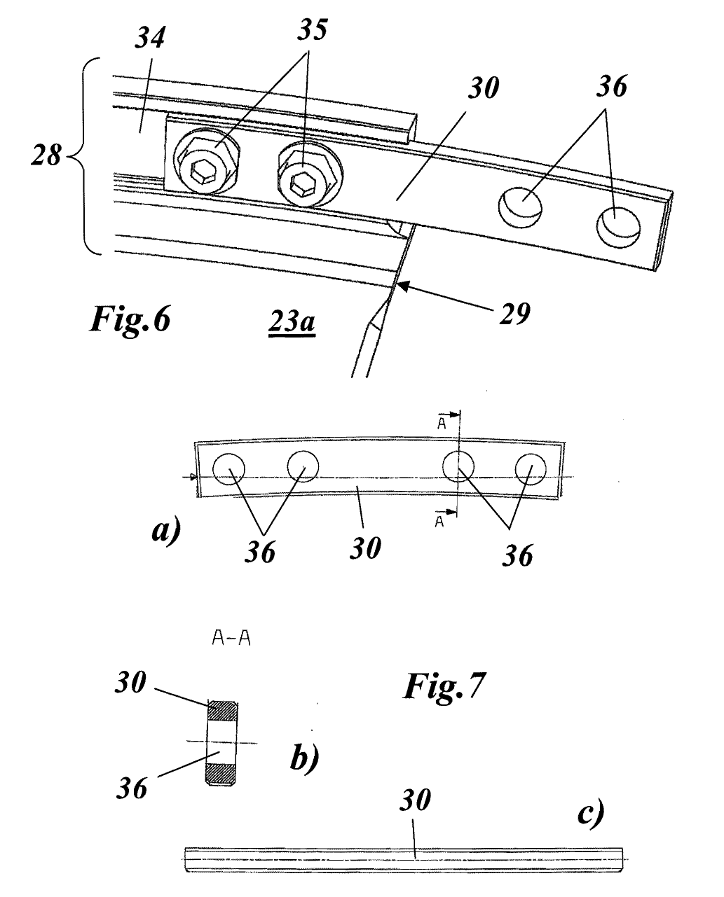

FIGS. 4 and 5 show a detail—viewed from different viewing angles—of the halves 23a, 23b, which abut against one another on the separating plane 29, of the outer shell 23, with a screwed bridge 30, arranged on the flange 34, according to one preferred exemplary embodiment of the invention. The bridge 30 itself is illustrated in various views in FIGS. 7a to 7c. The bridge 30 is in the form of an elongated flat strip with the rectangular cross section, which has the slightly curved shape of a circular arc segment. The length of the bridge 30 is chosen such that two attachment holes 36 can in each case be incorporated, at an adequate distance from one another, on both sides of the separating plane 29, and are used to screw/bolt the bridge 30 to the two welded half-shells 23a, 23b. If the bridge 30 is screwed, appropriate screws 35 are used, as shown in FIGS. 4 and 5. During assembly, the bridge—as already mentioned above—is first of all screwed to the upper half 23a of the outer shell, as shown in FIG. 6, before the half-shells 23a, 23b are then joined together. A corresponding procedure also applies to the inner shell 33.

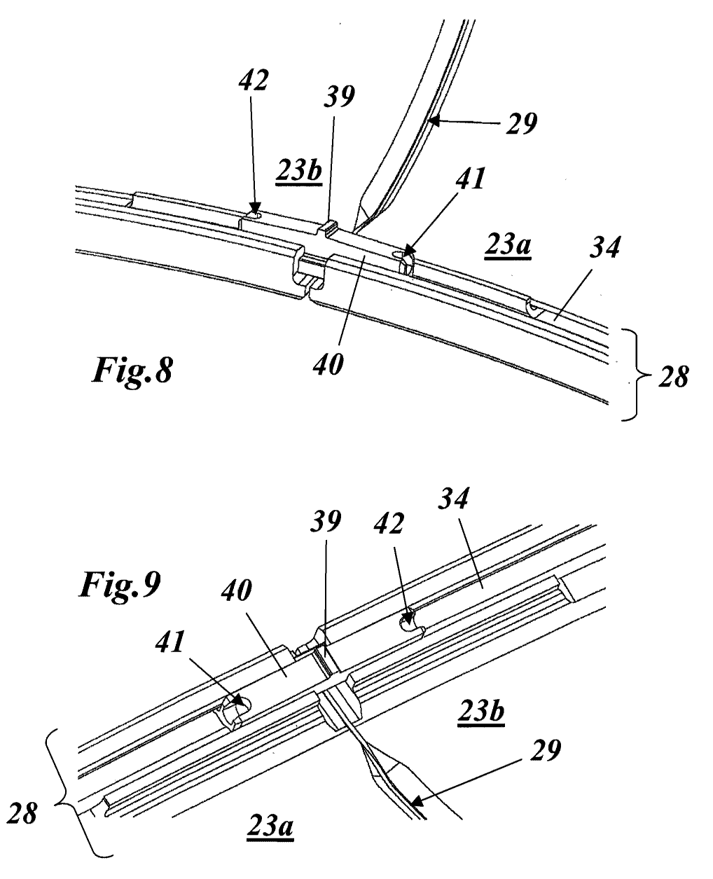

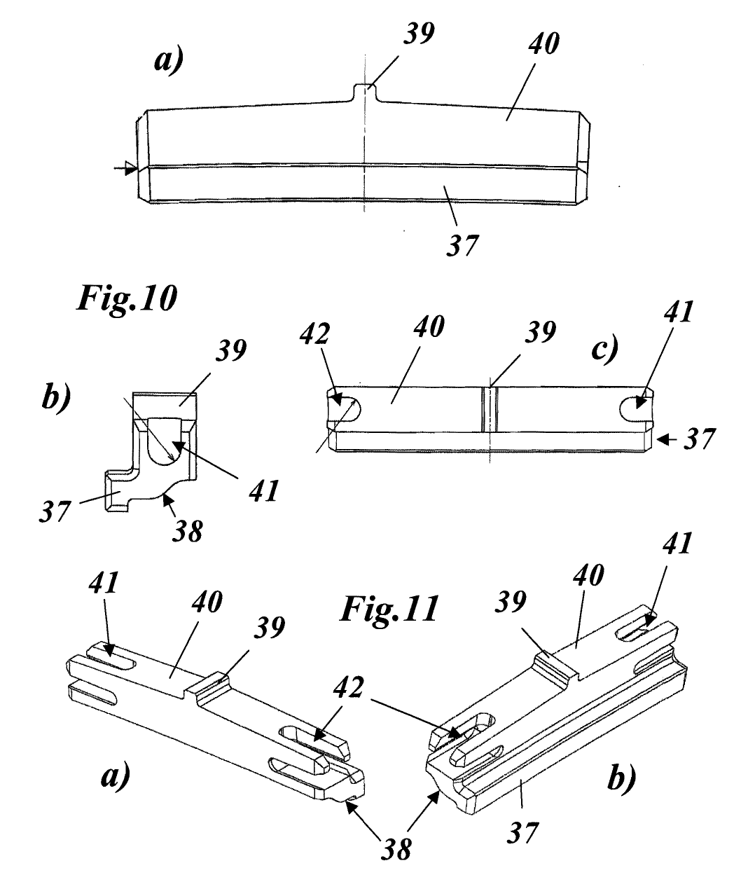

A connecting element 40 as shown in FIG. 8-10 or 11 is preferably used as a load-reducing arrangement with a welded bridge. The cross-sectional contour of the bridge 40 (FIG. 10b) is matched to the cross-sectional contour of the flange groove 34 such that the bridge 40 can be inserted into the groove 34 in an interlocking manner and, at the same time, engages with a foot strip 37 in an undercut in the groove 34. A stud 39 which projects laterally is provided in the center on the upper face of the bridge 40, to which stud 39 a striking tool can be applied when the bridge 40 is being knocked into the groove 34. A corrugated base surface 38 is formed (FIG. 10b) on the lower face of the bridge 40, creating a cooling channel, which runs in the circumferential direction of the flange 28, between the bridge 40 and the groove base. Notches 41, 42 in the form of fillets are advantageously arranged at the ends of the bridge 40 and are introduced partially on one side (FIG. 10c) or as a cruciform (FIG. 11). The radii of curvature of the notches may in this case vary.

Overall, the novel, interlocking connecting elements, which act as structure bridges for the combustion chamber shell separating plane, significantly ensure better force transmission at the ends of the separating plane.

In this case, various deviations and variants on a basic embodiment are possible within the scope of the invention:
the bridges (40) may have notches (41, 42) in the form of fillets at their ends in order to improve the mechanical integrity—better power flow transmission, breaking of the force peaks;
the notches in the bridge can be incorporated partially on one side or as a cruciform;
the radii of the notches illustrated in FIG. 10 may vary;
the wall thicknesses of the two illustrated bridges (30, 40) may vary;
the bridges may have turbulence ribs added to them on the cooling-air side in order to increase the cooling effectiveness;
the bridges could be cooled with impact cooling air on the cooling-air side, in order to improve the cooling effectiveness;
in order to make it easier to fit them to the upper face, the bridges may have a stud (39) in order to allow them to be moved more easily by striking them with a hammer; and
any type of adequate welding process may be used in the workshop for welding the bridges to the flange.

### LIST OF REFERENCE SYMBOLS

10 Gas turbine
11 Turbine housing
12 Rotor
13 Turbine
14 Plenum chamber
15 Combustion chamber
16 Burner (double-cone or EV burner)
17 Compressor
18 Combustion chamber shroud
19 Front plate
20 Front plate cooling air
21 Outer cooling jacket
22 Outer cooling channel
23 Outer shell
23a Upper half of the outer shell
23b Lower half of the outer shell
24 Attachment element
25 Hot-gas channel
26 Hot-gas flow
27 Axis
28 Flange
29 Separating plane
30, 40 Connecting element (bridge)
31 Inner cooling jacket
32 Inner cooling channel
33 Inner shell
34 Groove
35 Screw
36 Attachment hole
37 Foot strip
38 Base surface (corrugated)
39 Stud
41, 42 Notch (in the form of a fillet)

What is claimed is:

1. A thermal machine comprising an annular combustion chamber (15, 25) which is bounded on the outside by an outer shell (23) and an inner shell (33), the outer shell (23) and the inner shell (33) are each split on a separating plane (29) into an upper half (23a) and a lower half (23b), which are mechanically interlocked by welding one to the other on the separating plane (29), wherein an additional mechanical interlock (30, 40) is provided on the separating planes (29) in order to absorb tensile and shear forces acting on the separating planes (29).

2. The thermal machine as claimed in claim 1, wherein a connecting element (30, 40) which extends over the separating plane (29) and is in the form of a bridge is in each case provided as the additional mechanical interlock.

3. The thermal machine as claimed in claim 2, wherein the outer shell (23) and the inner shell (33) have a flange (28) at the inlet and/or outlet of the combustion chamber (15, 25), and the connecting elements (30, 40) are flanges (28) arranged on the outside of one of these outer shells or even inner shells.

4. The thermal machine as claimed in claim 3, wherein the flange (28) has a circumferential groove (34) on the outside, and the connecting elements (30, 40) are inserted into the groove (34).

5. The thermal machine as claimed in claim 2, wherein the connecting elements (30) are detachably connected to the two halves (23a, 23b) of the outer shell (23) and of the inner shell (33), respectively.

6. The thermal machine as claimed in claim 5, wherein the connecting elements (30) are detachably connected to the two halves (23a, 23b) of the outer shell (23) and inner shell (33), respectively, by screws (35) or bolts.

7. The thermal machine as claimed in claim 2, wherein the connecting elements (40) are welded, to the two halves (23a, 23b) of the outer shell (23) and inner shell (33).

8. The thermal machine as claimed in claim 7, wherein the groove (34) and the connecting elements (40) are configured such that the connecting elements (40) are held in the groove (34) by an interlock (37).

9. The thermal machine as claimed in claim 2, wherein the connecting elements (40) have notches (41, 42) in the form of fillets to improve the mechanical integrity at ends thereof.

10. The thermal machine as claimed in claim 2, wherein the connecting elements (40) have a stud (39) on an upper face thereof to improve assembly capability.

11. The thermal machine as claimed in claim 2, wherein the connecting elements (40) have a corrugated base surface (38) on a lower face thereof, defining cooling channels.

12. A method for assembling a thermal machine comprising an annular combustion chamber (15, 25) which is bounded on the outside by an outer shell (23) and an inner shell (33), the outer shell (23) and the inner shell (33) are each split on a separating plane (29) into an upper half (23a) and a lower half (23b), which are welded to one another on the separating plane (29), wherein an additional mechanical interlock (30, 40) is provided on the separating planes (29) in order to absorb tensile and shear forces acting on the separating planes (29), the method comprising inserting a connecting element (30, 40) into the upper half (23a) of the respective shell (23, 33), which is separated into an upper half (23a) and a lower half (23b); placing the two halves (23a, 23b) one on top of the other; driving the connecting element (30, 40) into the lower half (23b) of the respective shell (23, 33); and connecting the connecting element (30, 40) to the two halves (23a, 23b) in a final position.

13. The method as claimed in claim 12, wherein, in the first step, the connecting element (40) is inserted loosely into the upper half (23a), and is welded to the two halves (23a, 23b) in the final position.

14. The method as claimed in claim 12, wherein, in the first step, the connecting element (30) is inserted into the upper half (23a) at its final position, and is secured by screws (35) or bolts, and, in the third step, the upper half (23a) is positioned while the connecting element (30) is driven in on the lower half (23b) at the same time.
